(19) United States
(12) Patent Application Publication
(10) Pub. No.: US 2007/0034753 A1
(43) Pub. Date: Feb. 15, 2007

(54) Vehicle desk platform

(76) Inventor: Brian A. Lee, Morgantown, WV (US)

Correspondence Address: BERENATO, WHITE & STAVISH, LLC, 6550 ROCK SPRING DRIVE, SUITE 240, BETHESDA, MD, 20817, US

(21) Appl. No.: 10/503,232

(22) PCT Filed: Jan. 31, 2003
(86) PCT No.: PCT/US03/02709

§ 371 Date: Oct. 10, 2006

(30) Foreign Application Priority Data
Jan. 31, 2002 (US) 60353431

(51) Int. Cl. F16L 3/00

(52) U.S. Cl. 248/121

(57) ABSTRACT

A mobile desk for use in a vehicle or on another mobile platform to support various portable electronic devices, comprises a mounting table assembly provided for securely holding the portable electronic device, a base assembly removably secured in a passenger compartment of the motor vehicle, and an adjustable pole assembly extending between the mounting table assembly and the base assembly through swivel ball joint assemblies. The pole assembly includes pair of telescopic pole sections pivotally adjustable relative to each other. The mounting table assembly comprises a table plate member provided with an electronic device securing system, a lighting fixture, a display holder, an electric power inverter assembly for providing the mobile desk with a number of DC and AC outlets, and a built-in surge protector. The mobile desk further comprises an accessory supporting device adapted for supporting relatively small electronic devices, and a printer supporting device.

### CROSS-REFERENCED TO RELATED APPLICATION

This application claims the benefit under 35 U.S.C. 119(e) of U.S. Provisional Application No. 60/353,431 filed Jan. 31, 2002 naming Brian A. Lee.

### FIELD OF THE INVENTION

The present invention relates to supporting stands in general, and more particularly to a mobile desk for use in a vehicle or on another mobile platform to support various electronic devices, such as laptop computers, personal digital assistants (PDA), mobile phones, etc., for a user such as a driver or a passenger as a mobile office.

### BACKGROUND OF THE INVENTION

Portable electronic devices, such as laptop computers, palmtop computers, fax machines, PDAs, mobile phones, etc. and their peripheral devices have become very popular in the business, law enforcement and medical world. Especially popular among those who travel in a motor vehicle, such as salesmen, couriers, police officers, paramedics, etc., the portable electronic devices allow one essentially to take his business on the road, creating a virtual office wherever he goes, thus creating a virtual office in the motor vehicle. Using various peripheral accessories such as portable printers, CD-ROMs and modems, many laptop users have access to most of the features and functionality that they have grown accustomed in their office.

However, using the conventional passenger compartment of the motor vehicle as an office space is inconvenient, cumbersome and unsafe. Portable laptop users often place their computers on their laps, on a passenger seat or in other awkward positions where desktop space is limited, resulting in uncomfortable working conditions and a general lack of organization. Thus, there is a need for a mobile desk adapted to support the personal laptop computers, as well as other portable electronic devices, so that the individual can use them in a comfortable, safe and organized manner.

Attempts have been made to meet those needs and create a mobile desk adapted to be securely mounted in the passenger compartment of the motor vehicle for supporting the laptop computer. Several known devices have been marketed under the names “Mobile Desk®” and “LapTraveler®”. These desks generally include a base mount, a laptop support table, and a telescoping upright post extending therebetween. The telescoping upright post is angularly adjustably connected to both the base mount and the laptop support table through a swivel ball joint. However, these prior mobile desks have some drawbacks, such as limited adjustability, lack of additional support means for holding peripheral accessories and other necessary electronic devices. Moreover, these devices require a separate electric power inverter if the user wants to supply electric current to the laptop computer and the peripheral accessories.

Thus, there is a need for a mobile desk for use in motor vehicles and the like to support various electronic devices, such as laptop computers, personal digital assistants (PDA), mobile phones, etc., and various portable peripheral accessories for use by a user in a mobile office, having improved adjustability and provided with a built-in power inverter and a set of power outlet sockets.

### SUMMARY OF THE INVENTION

The present invention provides a novel mobile desk for use in a vehicle or other mobile platform to support various portable electronic devices, such as laptop computers, personal digital assistants (PDA), mobile phones, etc., and various portable peripheral accessories for a user such as a driver or a passenger as a mobile office.

The mobile desk of the present invention comprises a mounting table assembly provided securely holding a portable computer, such as a laptop, a base assembly removably secured in a passenger compartment of the motor vehicle, and an adjustable pole assembly extending between the mounting table assembly and the base assembly. The mobile desk further includes a first swivel ball joint assembly adapted to adjustably secure the pole assembly to the mounting table assembly, and a second swivel ball joint assembly adapted to adjustably secure the pole assembly to the base assembly, thus allowing a user, which may be a driver or passenger of the motor vehicle, to selectively orient the mounting table assembly in virtually any desirable position relative to the user.

The mounting table assembly comprises a substantially rectangular, flat table plate member having a top surface and an opposite bottom surface, and a front flange and a rear flange. The top surface and the front flange of the table plate member are adapted for supporting the portable computer device thereon, such as the laptop. The top surface of the table plate member is provided with a set of vibration damping elements made of any appropriate elastomeric material, while a distal edge of the front flange is covered with an elastomeric weather-strip. Furthermore, the top surface of the table plate member is provided with a laptop computer securing system including two pairs of elongated parallel tracks in the table plate member, and a pair of L-shaped brackets each adapted to slide and be selectively positioned and locked in one of the two pairs of the tracks in order to firmly clamp the laptop computer between the brackets and the front flange of the table plate member.

Moreover, the mounting table assembly may be provided with a lighting fixture secured thereto by a flexible interconnection element for illuminating the laptop computer.

The mounting table assembly may also be provided with a display holder adapted for selectively supporting a display panel of the laptop computer in an open position and stabilizing the display panel during heavy acceleration and/or emergency breaking of the motor vehicle.

The mounting table assembly is also provided with a hold-down strap provided for firmly fastening the laptop computer to the top surface of the table plate member.

The mounting table assembly further includes an electric power inverter assembly supplied by a direct electric current from an electric battery (not shown) of a motor vehicle or other device for providing the mobile desk with a number of DC and AC outlets.

The electric power inverter assembly includes an electric power inverter device secured to the bottom surface of the table plate member adjacent to the rear flange thereof, a set of female cigarette lighter ports providing 12V DC outlets for appropriate portable devices for use within the passenger compartment of the motor vehicle, such as mobile (cellular) phone, mobile phone charger, CD player, GPS device, etc., and a set of conventional household-type electrical sockets providing 110V or 220V DC outlets for appropriate portable devices for use within the passenger compartment of the motor vehicle, such as laptop computer, printer, etc. The electric power inverter device also includes a built-in surge protector and an On/Off switch with LED lamp to indicate when the inverter is turned on (or off).

Moreover, the rear flange of the table plate member may be provided with at least one universal serial bus (USB) port for connecting appropriate external peripheral electronic devices to the laptop computer.

The adjustable pole assembly extending between the mounting table assembly and the base assembly includes a pair of substantially straight pole sections pivotally adjustable relative to each other by means of a pivotally adjustable, lockable knuckle. Each of the pole sections of the pole assembly has a selectively adjustable length. Such an arrangement of the pole assembly allows to selectively orient the mounting table assembly in virtually any desirable position relative to the user.

The base assembly of the mobile desk is removably secured in a passenger compartment of the motor vehicle. Preferably, the base assembly is fixedly secured to a bolt mounting a supporting rail of a passenger seat to a floor of the passenger compartment of the motor vehicle.

The mobile desk of the present invention further comprises an accessory supporting device adapted for supporting relatively small electronic devices, such as mobile phone, PDA, etc. The accessory supporting device comprises an accessory clamp adjustably positioned to one of the pole sections of the pole assembly, at least one flexible tubular gooseneck secured to the accessory clamp at one end thereof, and at least one accessory support attachment attached to a distal end of the flexible gooseneck through swivel ball joint.

The mobile desk of the present invention is provided with a printer supporting device adapted for supporting various electronic peripheral devices, such as computer printers, fax machines or the like. The printer supporting device comprises a sleeve member adjustably mounted to one of the pole sections of the pole assembly, a support tube radially extending from the sleeve member for supporting a printer table through a ball joint.

Therefore, the mobile desk in accordance with the present invention represents a novel arrangement for supporting various electronic devices, such as laptop computers, personal digital assistants (PDA), mobile phones, etc., and various portable peripheral accessories for use by a user in a mobile office, having broad adjustability range and provided with a built-in power inverter and a set of power outlet sockets.

### BRIEF DESCRIPTION OF THE DRAWINGS

Other objects and advantages of the invention will become apparent from a study of the following specification when viewed in light of the accompanying drawings, wherein:

FIG. 1 is a perspective view of a mobile desk in accordance with the first exemplary embodiment of the present invention;

FIG. 2 is an exploded view of the mobile desk in accordance with the first exemplary embodiment of the present invention;

FIG. 3 is a left side view of the mobile desk in accordance with the first exemplary embodiment of the present invention in the deployed position;

FIG. 4 is a rear view of the mobile desk in accordance with the first exemplary embodiment of the present invention in the deployed position;

FIG. 5 is a front perspective view of a mounting table assembly in accordance with the preferred embodiment of the present invention;

FIG. 6 is a rear view of the mounting table assembly in accordance with the preferred embodiment of the present invention;

FIG. 7 is a rear perspective view of the mounting table assembly in accordance with the preferred embodiment of the present invention;

FIG. 8 is a side view of the mounting table assembly in accordance with the preferred embodiment of the present invention;

FIG. 9 is a side view of the mounting table assembly in accordance with the preferred embodiment of the present invention with a laptop computer in an open position supported thereon;

FIG. 10 is a front perspective view of a an electric power inverter assembly in accordance with the preferred embodiment of the present invention;

FIG. 11 is a rear perspective view of the electric power inverter assembly in accordance with the preferred embodiment of the present invention;

FIG. 12 is a front perspective view of a table plate member of the mounting table assembly in accordance with the preferred embodiment of the present invention;

FIG. 13 is a rear view of the table plate member of the mounting table assembly in accordance with the preferred embodiment of the present invention;

FIG. 14 is a bottom perspective view of the mounting table assembly in accordance with the preferred embodiment of the present invention;

FIG. 15 is a perspective view of a base assembly in accordance with the present invention;

FIG. 16 is a top view of a front passenger seat mounted to a floor in a passenger compartment of a motor vehicle;

FIG. 17 is a partial side view of the mobile desk of the present invention mounted to the floor in the passenger compartment of the motor vehicle;

FIG. 18 is a partial top view of the mobile desk of the present invention mounted to the floor in the passenger compartment of the motor vehicle;

FIG. 19 is a top view of an accessory clamp of the present invention;

FIG. 20 is a perspective view of a printer supporting accessory for the mobile desk of the present invention;

FIG. 21 is a side view of the printer supporting accessory for the mobile desk of the present invention;

FIG. 22 is a perspective view of a mobile desk in accordance with the second exemplary embodiment of the present invention;

FIG. 23 is a front view of the mobile desk in accordance with the second exemplary embodiment of the present invention in the deployed position.

### DETAILED DESCRIPTION OF PREFERRED EMBODIMENTS

The preferred embodiments of the present invention will now be described with reference to the accompanying drawings.

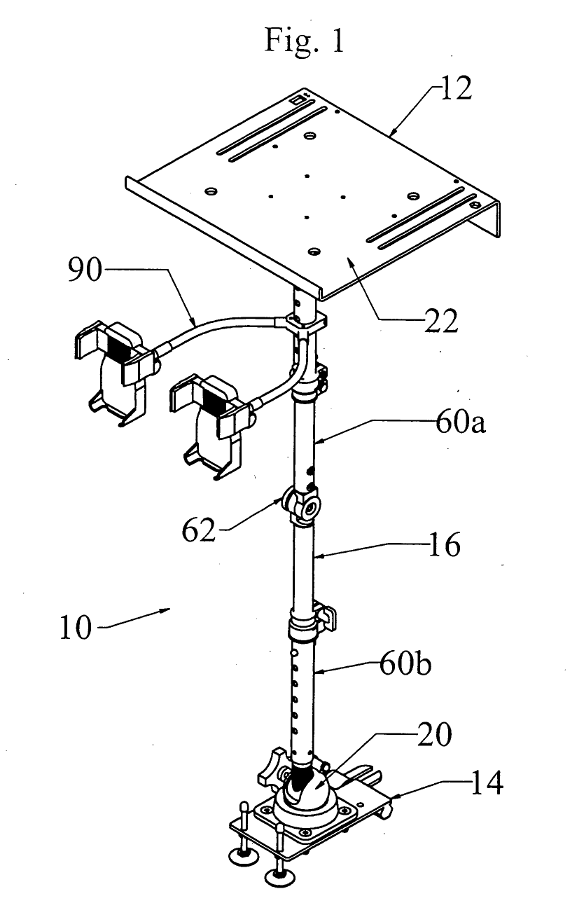

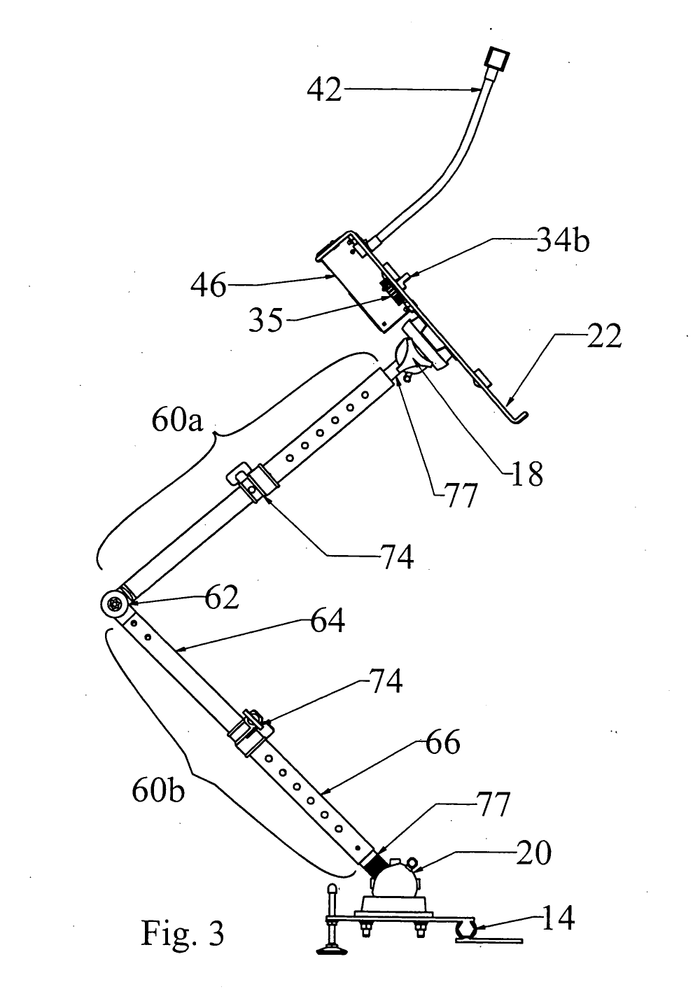

FIGS. 1-3 of the drawings illustrate in general a first exemplary embodiment of a mobile desk in accordance with the present invention, referred to generally at 10, for use in a motor vehicle or the like to support various electronic devices, such as laptop computers, personal digital assistants (PDA), mobile phones, etc., and various portable peripheral accessories for use by a driver or a passenger as a mobile office. The mobile desk 10 comprises a mounting table assembly 12 provided securely holding a portable computer, such as a laptop, a base assembly 14 removably secured in a passenger compartment of the motor vehicle, and an adjustable pole assembly 16 extending between the mounting table assembly 12 and the base assembly 14. The mobile desk 10 further includes a first swivel ball joint assembly 18 adapted to adjustably secure the pole assembly 16 to the mounting table assembly 12, and a second swivel ball joint assembly 20 adapted to adjustably secure the pole assembly 16 to the base assembly 14, thus allowing a user, which may be a driver or passenger of the motor vehicle, to selectively orient the mounting table assembly 12 in virtually any desirable position relative to the user. It will be appreciated by those skilled in the art that the first and second swivel ball joint assemblies 18 and 20 may be of any appropriate structure well known in the art.

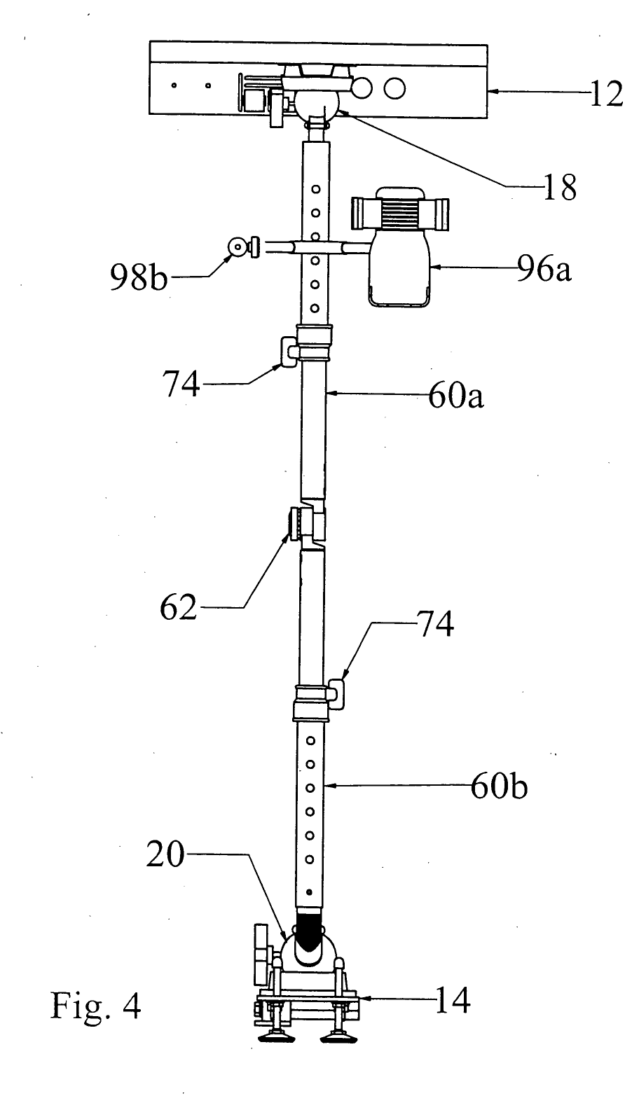

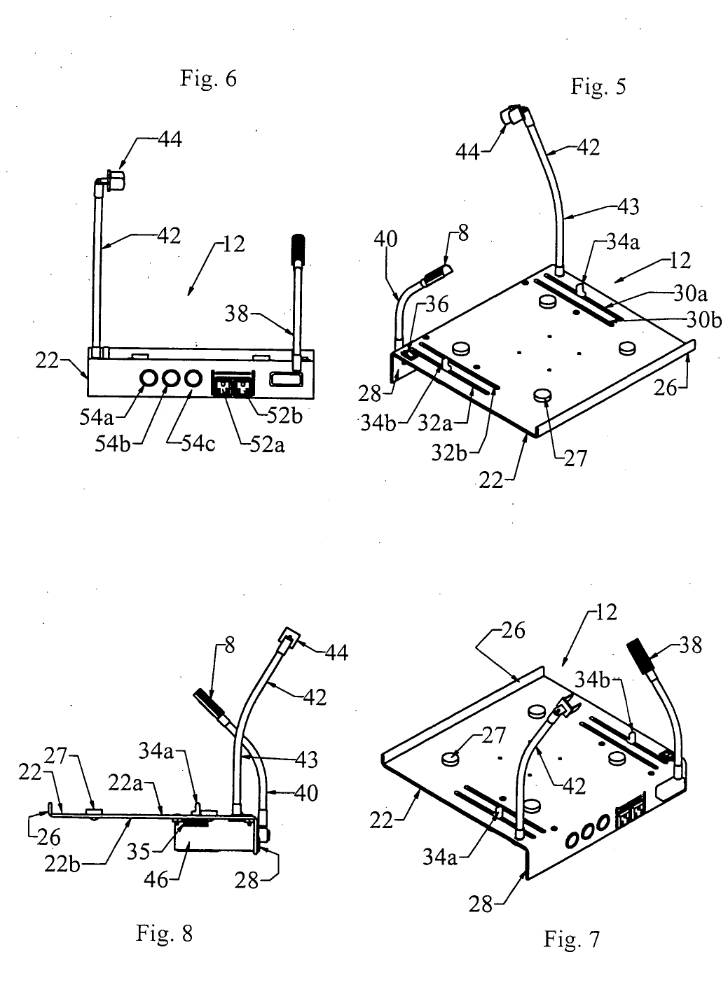

Preferably, as illustrated in details in FIGS. 4-8, the mounting table assembly 12 comprises a substantially rectangular, flat table plate member 22 having a top surface 22a and an opposite bottom surface 22b, and a front flange 26 extending substantially perpendicularly from the top surface 22a and a rear flange 28 extending substantially perpendicularly from the bottom surface 22b. Preferably, the table plate member 22 of the mounting table assembly 12 is thermoformed from 3/16″ Acrylonitrile Butadiene Styrene (ABS) material with a scratch resistant haircell finish for exceptional strength and durability.

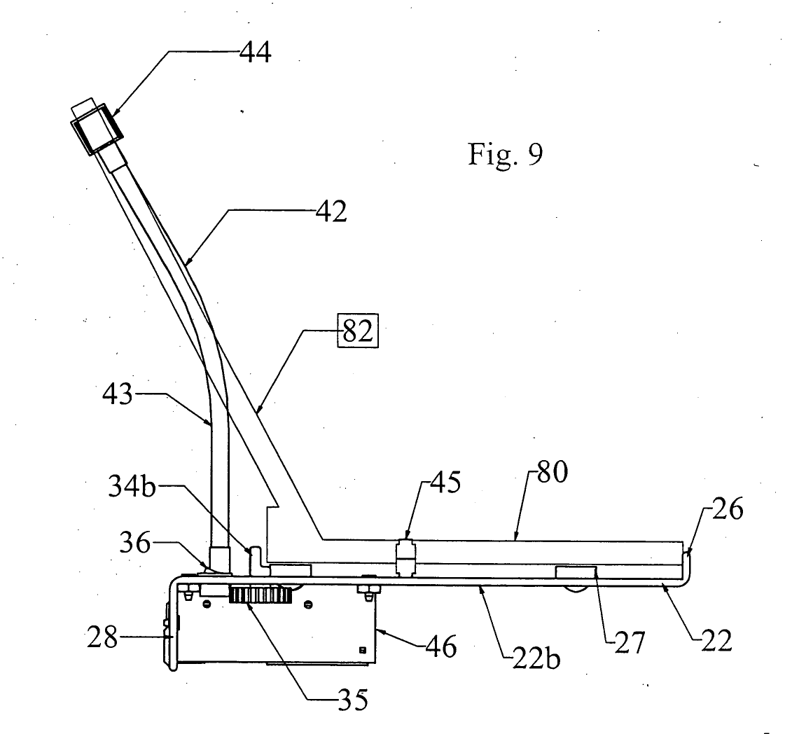

The top surface 22a and the front flange 26 of the table plate member 22 are adapted for supporting the portable computer device thereon, such as the laptop. Preferably, the top surface 22a of the table plate member 22 is provided with a set of vibration damping elements 27 made of any appropriate elastomeric material, while a distal edge of the front flange 26 is covered with an elastomeric weather-strip. Furthermore, the top surface 22 of the table plate member 22 is provided with a laptop computer securing system including two pairs of elongated parallel tracks 30a, 30b and 32a, 32b in the table plate member 22, and a pair of L-shaped brackets 34a and 34b each adapted to slide and be selectively positioned and locked in one of the two pairs of the tracks 30a, 30b and 32a, 32b in order to firmly clamp the laptop computer 80 between the brackets 34a and 34b and the front flange 26 of the table plate member 22, as illustrated in FIG. 9. Preferably, the brackets 34a and 34b are controlled by thumbscrews 35 underneath the table plate member 22 and are covered with any appropriate elastomeric material in order to further dampen vibrations experienced by the laptop computer in the motor vehicle. It will be appreciated by those skilled in the art that any other appropriate structure of selectively controlling position of the brackets 34a and 34b on the top surface 22a of the table plate member 22 is within the scope of the present invention.

The mounting table assembly 12 may also be provided with a lighting fixture 38 for illuminating the laptop computer 80. The lighting fixture 38 is secured to the table plate member 22 by a flexible interconnection element, preferably in the form of a flexible tubular gooseneck 40 that facilitates orientation of the lighting fixture 38 with respect to the laptop computer 80 in an open position.

Moreover, the mounting table assembly 12 may be provided with a display holder 42 adapted for selectively supporting a display panel 82 of the laptop computer 80 in an open position and stabilizing the display panel 82 during heavy acceleration and/or emergency breaking of the motor vehicle. Preferably, the display holder 42 includes a flexible tubular gooseneck 43 secured to the table plate member 22 at one end thereof, and having a U-shaped element 44 at the other end thereof for engaging the display panel 82, as illustrated in FIG. 9. It will be appreciated by those skilled in the art that alternative ways to position the display panel 82 of the laptop computer 80 may be used.

The mounting table assembly 12 is also provided with a hold-down strap 45 provided for firmly fastening the laptop computer 80 to the top surface 22a of the table plate member 22, as illustrated in FIG. 9.

The mounting table assembly 12 further includes an electric power inverter assembly 46 supplied by a direct electric current from an electric battery (not shown) of the motor vehicle for providing the mobile desk 10 with a number of DC and AC outlets.

As illustrated in detail in FIG. 11, the electric power inverter assembly 46 includes an inverter housing 48 secured to the bottom surface 22b of the table plate member 22 adjacent to the rear flange 28 thereof, an electric power inverter device 50 mounted within the housing 48, and a set of female cigarette lighter ports 54a-54c mounted in the housing 48 and extending through openings 23a-23c in the rear flange 28 of the table plate member 22. Preferably, the housing 48 is manufactured of 6063 T5 aluminum. However, any other appropriate material for producing the housing 48 may be employed.

Further preferably, as illustrated, the mounting table assembly 12 is provided with the set of three female cigarette lighter ports. It will be appreciated by those skilled in the art that any appropriate number of the cigarette lighter ports, such as one, two, four, etc., is within the scope of the present invention. The female cigarette lighter ports 54a-54c conveniently provide 12V DC outlets for appropriate portable devices for use within the passenger compartment of the motor vehicle, such as mobile (cellular) phone, mobile phone charger, CD player, GPS device, etc.

The electric power inverter device 50 is provided for converting 12V DC current of the electric battery of the motor vehicle into AC current of the standard household 110 V or international 220 V voltage. The electric power inverter device 50, preferably in the form of a 400 Watt inverter, includes two conventional household-type electrical sockets 52a and 52b extending through openings 25a and 25b in the rear flange 28 of the table plate member 22. Although, the mounting table assembly 12 is illustrated with two AC electrical sockets, it will be appreciated by those skilled in the art that any appropriate number of the AC electrical sockets, such as one, three, four, etc., is within the scope of the present invention.

The AC electrical sockets 52a and 52b conveniently provide 110V or 220V DC outlets for appropriate portable devices for use within the passenger compartment of the motor vehicle, such as laptop computer, printer, etc. The electric power inverter device 50 also includes a built-in surge protector for protecting electronic equipment plugged into the inverter device 50 from the voltage and current spikes, such as during engine starting. Moreover, the inverter has an On/Off switch 36 with LED lamp to indicate when the inverter is turned on (or off). The On/Off switch 36 is preferably disposed on the top surface 22b of the table plate member 22, as illustrated in FIGS. 4-9.

Moreover, the rear flange 28 of the table plate member 22 may be provided with at least one USB port (not shown) for connecting appropriate external peripheral electronic devices to the laptop computer 80.

As further illustrated in FIGS. 1-3, the adjustable pole assembly 16 extending between the mounting table assembly 12 and the base assembly 14 includes a pair of substantially straight pole sections 60a and 60b pivotally adjustable relative to each other by means of a pivotally adjustable, lockable knuckle 62. It will be appreciated by those skilled in the art that any appropriate pivotally adjustable or swivel knuckle lockable in selective position may be employed in the mobile desk 10 of the present invention, such as one disclosed in U.S. Pat. No. 5,689,999 incorporated herein by reference. Preferably, the knuckle 62 may be pivotally adjusted at 10° increments and provide an angular span of 220°.

Each of the pole sections 60a and 60b of the pole assembly 16 has a selectively adjustable length. Preferably, the pole sections 60a and 60b are substantially identical, therefore, only one pole section 60b will be described in detail hereinbelow. However, it will be appreciated by those skilled in the art that the pole sections 60a and 60b may have different structure, given that both of them are selectively adjustable in length.

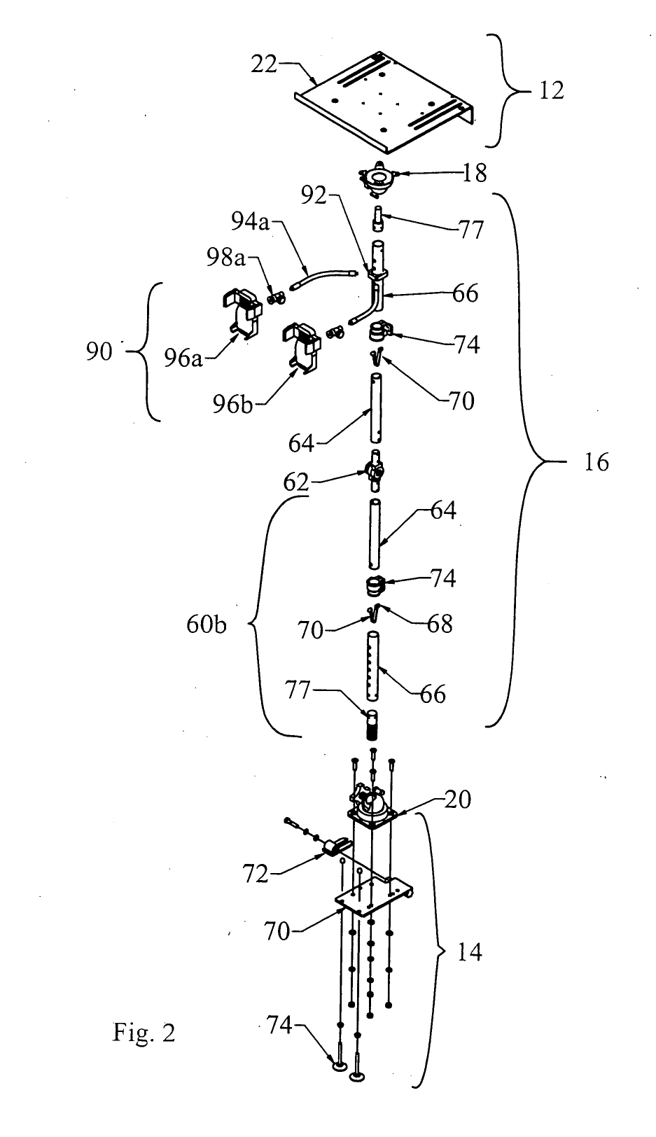

As illustrated in detail in FIG. 2, the telescopic pole section 60b comprises a rigid tubular member 64 that slideably engages a slightly larger rigid tubular member 66. In combination, the tubular members 64 and 66 define the telescopic sec pole section 60b. In order to selectively adjust the length, the telescopic pole section 60b further includes a push button pin 68 attached by a horseshoe spring 70 to a lower end of the rigid tubular member 64 and a series of spaced apart holes 72 formed in the larger rigid tubular member 66. In assembled condition, the push button pin 68 protrudes outwardly through one of the holes 72 and thereby securely holds the tubular member 64 a fixed distance relative the rigid tubular member 66. Thus, the retractable, spring biased pin 68, when it protrudes from one of the holes 72, maintain the tubes 64 and 66 in a fixed position relative to each other.

Moreover, the telescopic pole section 60b further includes a clamp device 74 disposed between the tubular members 64 and 66. The clamp device 74 having a rotary knob member 75 is provided for rigidly clamping the tubular members 64 and 66 together, thus effectively eliminating any relative movement therebetween.

As further illustrated in FIG. 2, the telescopic pole section 60b also comprises a swivel base stud 76 rigidly secured to a distal end of the tubular member 66. Preferably, the swivel base stud 76 has an axially serrated end portion 77, adapted to engage a complimentary serrated portion of the swivel ball joint assembly 19 providing better gripping. Alternatively, the axially serrated end portion 77 of the swivel base stud 77 may be provided without any serrations.

The adjustable, telescopic pole section 60a of the pole assembly 16 is secured to the mounting table assembly 12 though the first swivel ball joint assembly 18. It will be appreciated by those skilled in the art that any appropriate swivel ball joint assembly lockable in selective position may be employed in the mobile desk 10 of the present invention, such as one disclosed in U.S. Pat. No. 2,898,068 incorporated herein by reference. Preferably, as illustrated in FIG. 8, the first swivel ball joint assembly 18 is rigidly secured to the bottom surface 22b of the mounting table assembly 12 table plate member 22, and has a manually operable locking knob 19 adapted to clamp the swivel ball joint assembly 18 in a selected position.

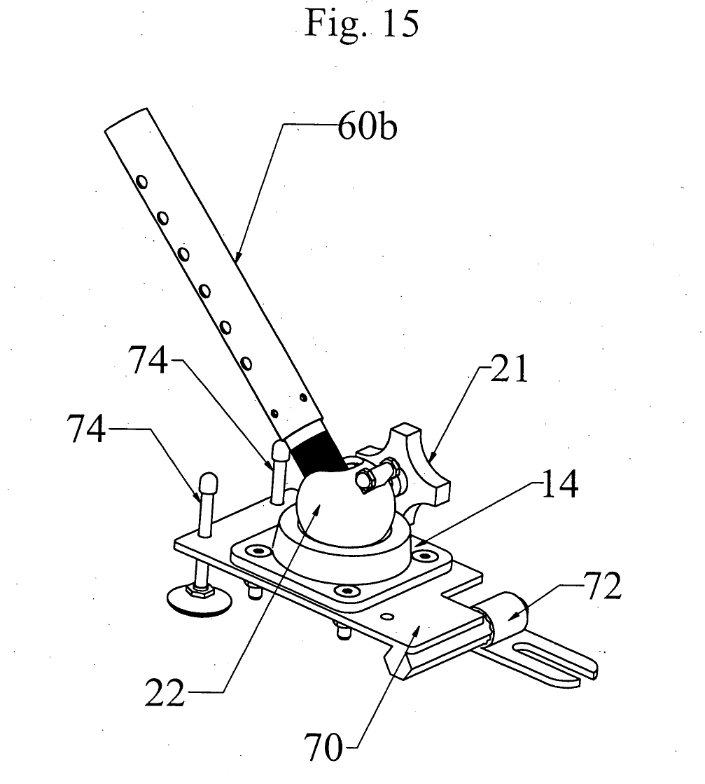

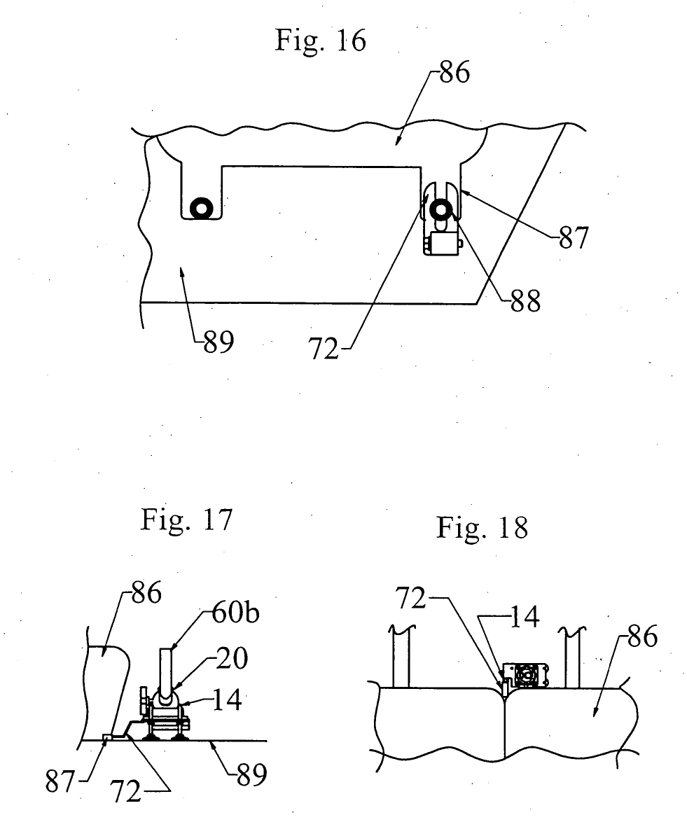

The base assembly 14 is removably secured in a passenger compartment of the motor vehicle. As illustrated in FIG. 15, the base assembly 14 comprises a mounting plate 70 fixedly attached to a fork-like bracket 72, and a pair of support feet 74 adapted to engage a floor of the passenger compartment of the motor vehicle and adjustably threaded into the mounting plate 70. The fork-like bracket 72 may be fixedly attached to the mounting plate 70 in a variety of angular positions. Preferably, the fork-like bracket 72 is adapted to be secured to a bolt 88 mounting a supporting rail 87 of a passenger seat 86 to a floor 89 of the passenger compartment of the motor vehicle, as illustrated in FIGS. 16-18.

The adjustable, telescopic pole section 60b of the pole assembly 16 is secured to the base assembly 14 though the second swivel ball joint assembly 20. It will be appreciated by those skilled in the art that any appropriate p swivel ball joint assembly lockable in selective position may be employed in the mobile desk 10 of the present invention, such as one disclosed in U.S. Pat. No. 2,898,068 incorporated herein by reference. Preferably, as illustrated in FIG. 15, the second swivel ball joint assembly 20 is rigidly secured to a top surface of the m mounting plate 70, and has a manually operable locking knob 21 adapted to clamp the swivel ball joint assembly 20 in a selected position.

In use, the mounting table assembly 12 may adjusted and securely locked to virtually any position selected by the user of the laptop computer, as the mobile desk 10 includes two swivel ball joint assemblies 18 and 20, and the pair of the telescopically adjustable pole sections 60a and 60b further angularly adjustable relative to each other through the pivotally adjustable, lockable knuckle 62.

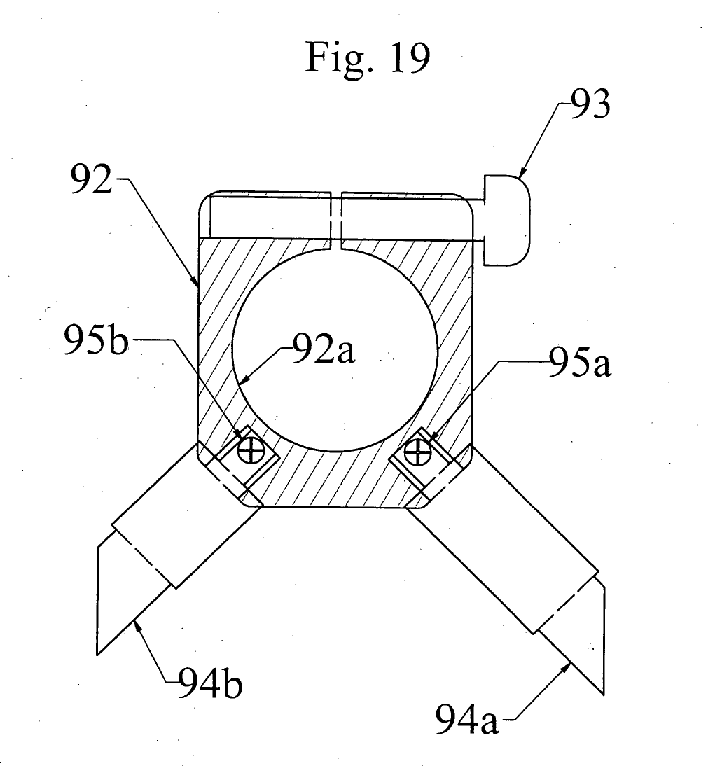

As shown in FIG. 1, the mobile desk 10 of the present invention is further provided with an accessory supporting device 90 adapted for supporting relatively small electronic devices, such as mobile phone, PDA, etc. (not shown). As further illustrated in FIG. 2, the accessory supporting device 90 comprises an accessory clamp 92 adjustably positioned to one of the pole sections 60a and 60b of the pole assembly 16, at least one but preferably two flexible tubular goosenecks 94a and 94b secured to the accessory clamp 92 at one end thereof. Preferably, the flexible goosenecks 94a and 94b are substantially identical. The distal ends of the flexible goosenecks 94a and 94b are provided with accessory support attachments 96a and 96b adjustably attached thereto through swivel ball joints 98a and 98b respectively. It will be appreciated by those skilled in the art that the accessory clamp 92 may be provided with more than two accessory support attachments. It will also be appreciated by those skilled in the art that the various accessory support attachments may be employed in the present invention, such as cellular phone holder, cellular phone charger, PDA cradle, GPS device holder, map or paper holder, etc. Preferably, as illustrated in detail in FIG. 19, the accessory clamp 92 has a substantially cylindrical bore 92a therethrough receiving one of the pole sections 60a and 60b of the pole assembly 16 and clamped to the pole assembly 16 by means of a clamping screw 93. The flexible goosenecks 94a and 94b are threaded into the accessory clamp 92 and clamped by means of screws 95a and 95b. Preferably, the accessory clamp 92 is mounted to the upper pole section 60a of the pole assembly 16. It will also be appreciated by those skilled in the art that the mobile desk 10 of the present invention may support more than one accessory supporting device.

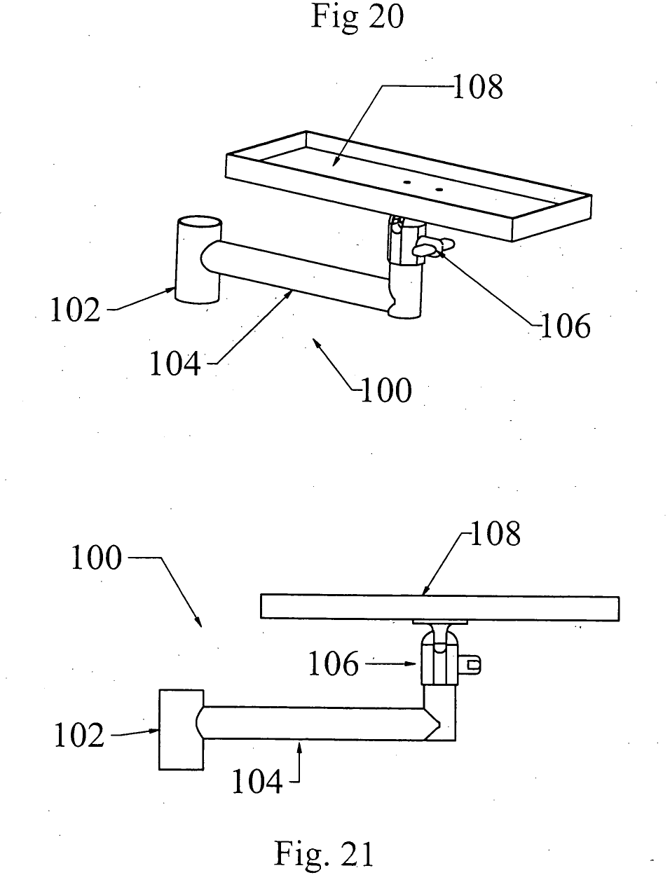

The mobile desk 10 of the present invention can also be provided with a printer supporting device 100 adapted for supporting various electronic peripheral devices, such as computer printers, fax machines or the like (not shown). As illustrated in FIGS. 20 and 21, the printer supporting device 100 comprises a sleeve member 102 adjustably mounted to one of the pole sections 60a and 60b of the pole assembly 16, a support tube 104 radially extending from the sleeve member 102 for supporting a printer table 108 through an adjustable ball joint 106. Preferably, the printer supporting device 100 is mounted to the lower pole section 60b.

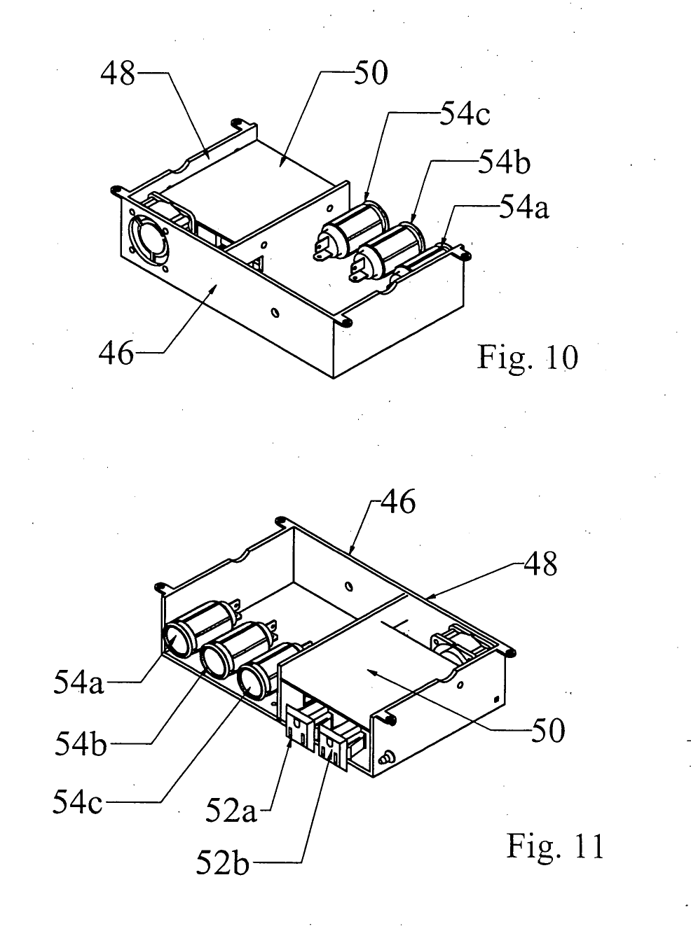

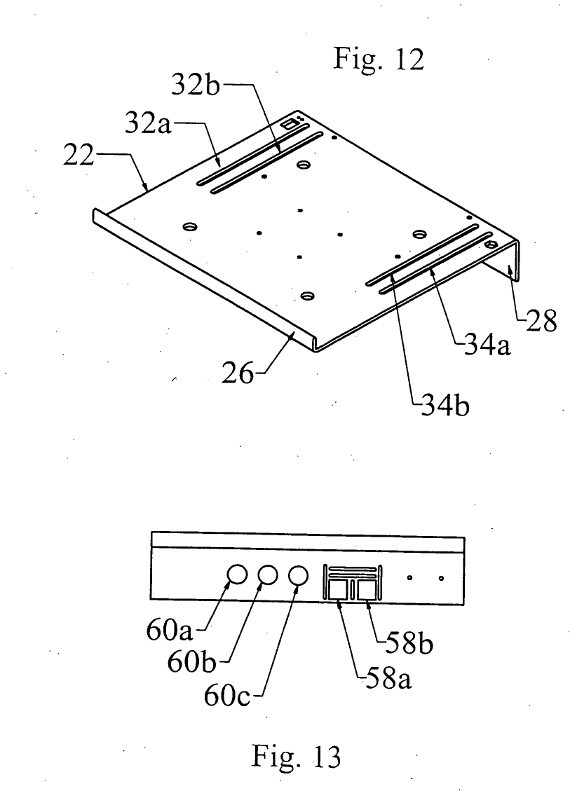

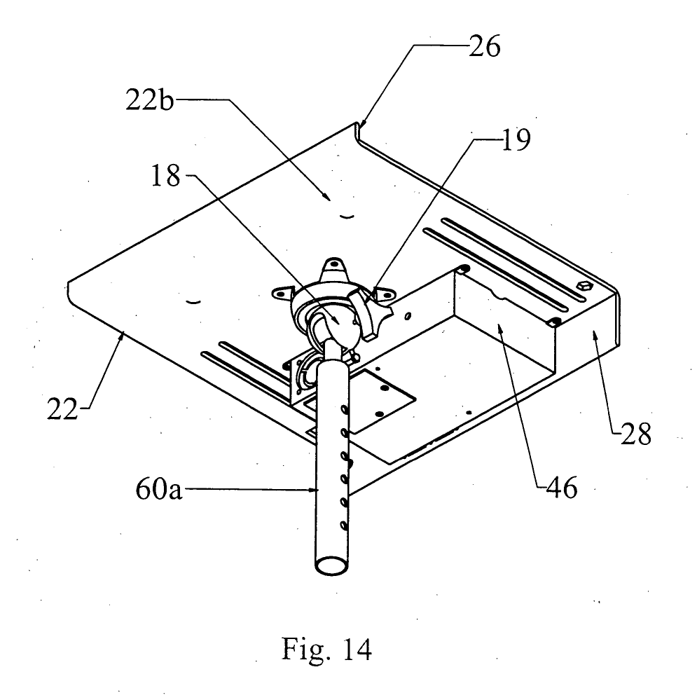

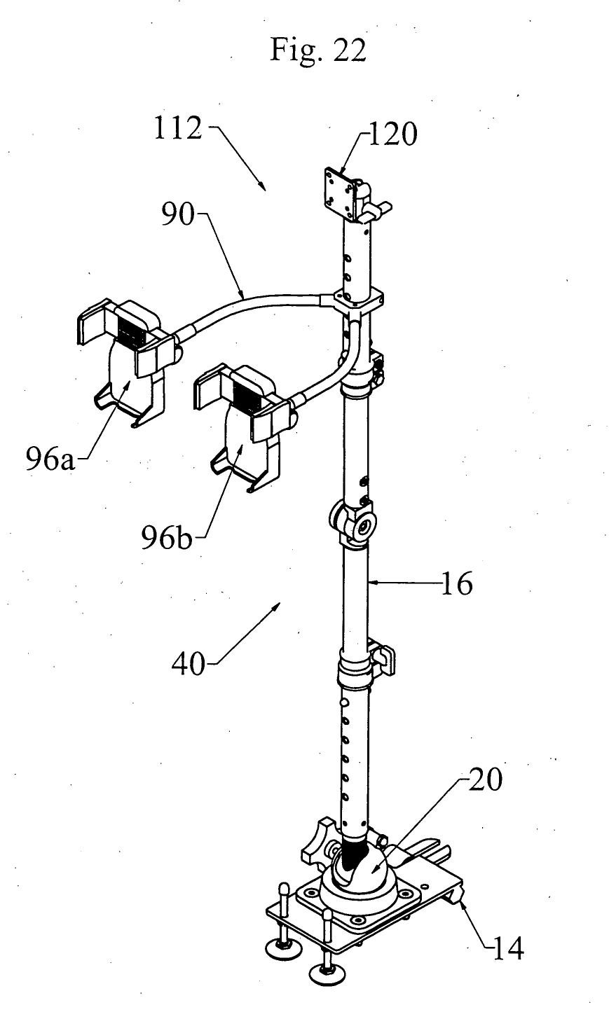

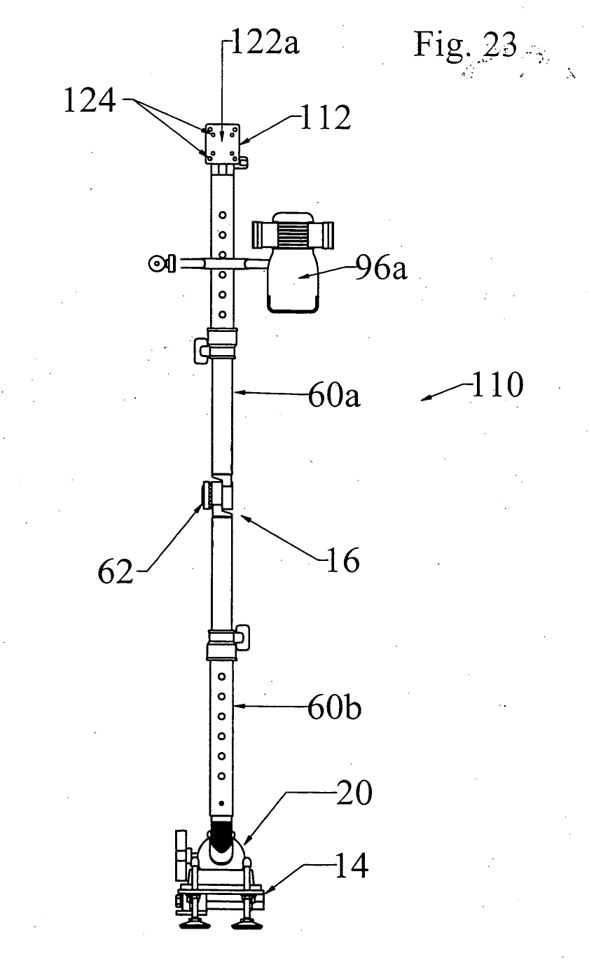

FIGS. 22-23 shows a second exemplary embodiment of a mobile desk in accordance with the present invention. Components, which are unchanged from, or function in the same way as in the first exemplary embodiment depicted in FIGS. 1-21 are labeled with the same reference characters, sometimes without describing detail since similarities between the corresponding parts in the two embodiments will be readily perceived by the reader. The mobile desk of FIGS. 22-23 corresponds substantially to the mobile desk of FIGS. 1-21, and only the mounting table assembly, which differ, will therefore be explained in detail below.

A mobile desk of the second exemplary embodiment of the present invention, generally depicted with reference character 110, comprises a mounting table assembly 112, a base assembly 14 removably secured in a passenger compartment of the motor vehicle, and an adjustable pole assembly 16 extending between the mounting table assembly 112 and the base assembly 14. The mobile desk 110 further includes a first swivel ball joint assembly 18 adapted to adjustably secure the pole assembly 16 to the mounting table assembly 112, and a second swivel ball joint assembly 20 adapted to adjustably secure the pole assembly 16 to the base assembly 14, thus allowing a user, which may be a driver or passenger of the motor vehicle, to selectively orient the mounting table assembly 112 in virtually any desirable position relative to the user. It will be appreciated by those skilled in the art that the first and second swivel ball joint assemblies 18 and 20 may be of any appropriate structure well known in the art.

As illustrated in details in FIGS. 22-23, the mounting table assembly 112 comprises a substantially square, flat table plate member 122 having a top surface 122a and an opposite bottom surface. Preferably, the table plate member 122 of the mounting table assembly 112 is thermoformed from 3/16″ Acrylonitrile Butadiene Styrene (ABS) material with a scratch resistant haircell finish for exceptional strength and durability.

The top surface 122a of the table plate member 122 is adapted for supporting a holder or cradle (such as the accessory support attachments 96a and 96b illustrated in FIGS. 1 and 2) of the small portable electronic device thereon, such as the palmtop, PDA, mobile phone, GPA device, etc. Preferably, the top surface 122a of the table plate member 122 is provided with a set of through holes 124 adapted to receive bolts used for fastening the accessory support attachments to the top surface 122a of the table plate member 122.

The foregoing description of the preferred embodiments of the present invention has been presented for the purpose of illustration in accordance with the provisions of the Patent Statutes. It is not intended to be exhaustive or to limit the invention to the precise forms disclosed. The embodiments disclosed hereinabove were chosen in order to best illustrate the principles of the present invention and its practical application to thereby enable those of ordinary skill in the art to best utilize the invention in various embodiments and with various modifications as are suited to the particular use contemplated, as long as the principles described herein are followed. This application is therefore intended to cover any variations, uses, or adaptations of the invention using its general principles. Further, this application is intended to cover such departures from the present disclosure as come within known or customary practice in the art to which this invention pertains. Thus, changes can be made in the above-described invention without departing from the intent and scope thereof. It is also intended that the scope of the present invention be defined by the claims appended thereto.

What is claimed is:

1. A mobile desk for supporting at least one portable electronic device on a vehicle, said mobile desk comprising:
a mounting table assembly provided for securely holding said at least one portable electronic device;
a base assembly adapted to be removably secured to said vehicle; and
an adjustable pole assembly extending between said mounting table assembly and said base assembly, wherein said pole assembly including a pair of pole sections pivotally adjustable relative to each other, each of said sections of said pole assembly having a selectively adjustable length.

2. The mobile desk as defined in claim 1, wherein each of said sections of said pole assembly includes a pair of rigid tubes slideably engaging each other so as to form a telescopic connection for selectively adjusting said length of each of said pair of said rigid tubes.

3. The mobile desk as defined in claim 1, wherein one distal end of said pole assembly is pivotally attached to said mounting table assembly, and the other distal end of said pole assembly is pivotally attached to said base assembly allowing a user to selectively orient said mounting table assembly in a desirable position.

4. The mobile desk as defined in claim 3, wherein one distal end of said pole assembly is attached to said mounting table assembly via a first ball joint assembly, and the other distal end of said pole assembly is attached to said base assembly via a second ball joint assembly allowing a user to selectively orient said mounting table assembly in said desirable position.

5. The mobile desk as defined in claim 1, wherein said mounting table assembly includes a substantially rectangular flat table plate member having a top surface and an opposite bottom surface, said front surface adapted for supporting said at least one portable electronic device thereon.

6. The mobile desk as defined in claim 1, further including at least one accessory supporting device mounted to said pole assembly provided for supporting said at least one portable electronic device.

7. The mobile desk as defined in claim 6, wherein said at least one an accessory supporting device includes an accessory clamp adjustably positioned to one of said pair of said pole sections of said pole assembly, at least one flexible gooseneck secured to said accessory clamp at one end thereof, and at least one accessory support attachment secured to said at least one flexible gooseneck at one end thereof.

8. The mobile desk as defined in claim 1, further including at least one printer supporting device mounted to said pole assembly provided for supporting a printer.

9. The mobile desk as defined in claim 1, wherein said mounting table assembly including at least one electrical power outlet.

10. The mobile desk as defined in claim 9, wherein said at least one electrical power outlet is an electrical socket providing a direct electric current.

11. The mobile desk as defined in claim 9, wherein said at least one electrical power outlet is an electrical socket providing an alternating electric current.

12. The mobile desk as defined in claim 11, wherein said at least one electrical power outlet is an electrical socket providing a 110V alternating electric current.

13. The mobile desk as defined in claim 11, wherein said at least one electrical power outlet is an electrical socket providing a 220V alternating electric current.

14. The mobile desk as defined in claim 9, wherein said mounting table assembly includes a substantially rectangular flat plate member having a top surface, a bottom surface and a rear flange extending substantially perpendicularly from said bottom surface, wherein said rear flange is provided with said at least one electrical power outlet.

15. The mobile desk as defined in claim 9, wherein said vehicle has an electric battery, said mobile desk further including an electronic inverter supplied by a direct electric current from said electric battery of said vehicle and electrically connected to said at least one electrical power outlet.

16. The mobile desk as defined in claim 15, wherein said mounting table assembly includes a substantially rectangular flat plate member having a top surface and a bottom surface, said top surface adapted for supporting said portable electronic device thereon, and wherein said inverter is mounted to said bottom surface of said plate member of said table assembly.

17. The mobile desk as defined in claim 15, wherein said electric power inverter includes a serge protector provided for protecting at least one portable electronic device plugged into said at least one electric power outlet from voltage and current spikes.

18. The mobile desk as defined in claim 1, wherein said mounting table assembly includes at least one USB port for connecting at least one external peripheral electronic device to said at least one portable electronic device.

19. A mobile desk for supporting at least one portable electronic device on a vehicle, said mobile desk comprising:
a mounting table assembly provided for securely holding said portable electronic device;
a base assembly adapted to be removably secured to said vehicle; and
an adjustable pole assembly extending between said mounting table assembly and said base assembly;
wherein said mounting table assembly includes an electric power inverter and at least one electrical power outlet electrically connected to said electric power inverter.

20. The mobile desk as defined in claim 19, wherein said vehicle has an electric battery and said electric power inverter is supplied by a direct electric current from said electric battery of said vehicle.

21. The mobile desk as defined in claim 19, wherein said at least one electrical power outlet is an electrical socket providing an alternating electric current.

22. The mobile desk as defined in claim 21, wherein said at least one electrical power outlet is an electrical socket providing a 110V alternating electric current.

23. The mobile desk as defined in claim 21, wherein said at least one electrical power outlet is an electrical socket providing 220V alternating electric current.

24. The mobile desk as defined in claim 19, wherein said at least one electrical power outlet providing a direct electric current.

25. The mobile desk as defined in claim 19, wherein said electric power inverter includes a serge protector provided for protecting at least one portable electronic device plugged into said at least one electric power outlet from voltage and current spikes.

26. The mobile desk as defined in claim 19, wherein said mounting table assembly includes at least one USB port for connecting at least one external peripheral electronic device to said at least one portable electronic device.

27. The mobile desk as defined in claim 19, further including at least one accessory supporting device mounted to said pole assembly provided for supporting said at least one portable electronic device.

28. A mobile desk for supporting at least one portable electronic device on a vehicle, said mobile desk comprising:
a mounting table assembly provided for securely holding said portable electronic device;
a base assembly adapted to be removably secured to said vehicle; and
an adjustable pole assembly extending between said mounting table assembly and said base assembly;
wherein said mounting table assembly includes at least one electrical power outlet.
